(19) United States
(12) Patent Application Publication
(10) Pub. No.: US 2002/0075850 A1
(43) Pub. Date: Jun. 20, 2002

(54) Method and apparatus for using the voice over internet protocol to handoff call connections

(75) Inventors: Agustin Salguero Cruz, Saltillo (MX); Roberto Iparrea Cervantes, Saltillo (MX); Cesar Garcia Lopez, Saltillo (MX)

Correspondence Address: Mark V. Muller, Jenkens & Gilchrist, P.C., Suite 3200, 1445 Ross Avenue, Dallas, TX, 75202-2799, US

(73) Assignee: Telefonaktiebolaget L M Ericsson (publ)

(21) Appl. No.: 09/745,229

(22) Filed: Dec. 20, 2000

(51) Int. Cl. H04L 12/66; H04Q 7/24

(52) U.S. Cl. 370/352; 370/338; 370/401

(57) ABSTRACT

Voice over Internet Protocol (VOIP) operations are utilized to substitute for the allocation of voice trunks in a conventional telecommunications network during intersystem handoff operations. A pair of VoIP gateways are in electronic communication with mobile switching centers. The VoIP gateways are connected by an Internet Protocol network. A determination is made that a handoff forward call connection operation should occur. A second VoIP gateway is allocated to the Target MSC, while a first VoIP gateway is allocated to the Serving MSC. A voice path is then completed using voice channels between the VoIP gateways and the MSCs, to allow the mobile station communication to be handed off from the Serving MSC to the Target MSC. Formatting and recovery of the voice audio signals occurs within the VoIP gateways as they are sent to and received from, respectively, the MSCs.

### BACKGROUND OF THE INVENTION

### Cross Reference to Related Applications

This application is related to U.S. patent application Ser. No. 09/464,124 filed Dec. 16, 1999, “Method for Conducting Handoff Back Communication Scenarios”; and U.S. patent application Ser. No. 09/540,073, filed Mar. 31, 2000, “Method for Conducting Handoff Back to Anchor Communication Scenarios” which are each incorporated herein by reference in their entirety.

### Technical Field

This invention relates generally to mobile cellular telephone communications, and more particularly, to a method of utilizing existing signaling protocols, such as the American National Standards Institute (ANSI)-41 protocol, to implement more efficient communication operations, including handoff operations, using the Voice over Internet Protocol (VoIP).

### History of Related Art

Unless telecommunication subscribers communicate through the same switch, voice and signaling trunks are typically required to support communications. These physical resources are appropriated within a network as required. For example, turning to FIG. 1, the typical prior art scenario illustrating two mobile telephone subscribers engaged in conversation, as once subscriber moves away from an anchor Mobile Switching Center (MSC) to a target MSC, is shown. In this figure, a voice call is established between mobile station 110 and mobile station 120 using the anchor MSC 160. During the course of the conversation, the mobile station 120 moves away from position 130, through position 140, to position 150. As the mobile station 120 moves away from the position 130 to the position 150, the mobile station 120 is assumed to move outside the coverage range available to the anchor MSC 160, and within the coverage range of the target MSC 170. The signaling trunks 180, 185 are used to communicate signaling messages for information interchange between the network entities 160, 170 and the Home Location Register (HLR) 175. As the mobile station 120 moves away from the anchor MSC 160, the anchor MSC 160 establishes communication with the target MSC 170 to request resources to continue the services offered to the mobile station 120. Thus, as the mobile station 120 is handed off from the anchor MSC 160 to the target MSC 170, various messages, such as HANDOFFMEASUREMENTREQUEST, FACILITIESDIRECTIVE, and MOBILESTATIONONCHANNEL messages (assuming we use ANSI-41 standard, for example) are sent and received using the signaling trunk 180 between the anchor MSC 160 and the target MSC 170.

The target MSC 170 will then seize resources to be assigned to the arriving mobile station 120. One of the resources required corresponds to the voice trunk 190, which carries speech from the anchor MSC 160 to the target MSC 170. The voice trunk 190 is necessary to continue the conversation between the mobile station 120 (now served by the target MSC 170) and the mobile station 110 (served by the anchor MSC 160).

The on-going conversation continues after the mobile station 120 has been handed off to the target MSC 170. Thus, the on-going call requires four signal interfaces: the first is the air interface 115 between the mobile station 110 and the anchor MSC 160; the second is the air interface 117 between the mobile station 120 and the target MSC 170; the third is the signaling trunk 180; and the fourth is the voice trunk 190. Therefore, a successful inter-exchange handoff requires air interface resources for a first subscriber, air interface resources for a second subscriber, a signaling trunk to carry control signaling between the anchor and target MSCs, and a voice trunk to support the call connection between the MSCs. If any of these resources is not available, especially the voice trunk connection 190, then the call cannot be handed off to the target MSC 170. Further, it is quite expensive to dedicate voice trunks between MSCs during network definition in anticipation of unknown call volumes.

Turning to FIG. 2, another illustration of interactions between network entities which accentuate the problem of voice communication over trunks in a network can be seen. Initially, the call connection between the telephone 310 and the cellular subscriber 350 includes a VoIP connection 370 between the telephone 310 and the Internet 320, a VoIP connection 380 between the Internet 320 and the anchor MSC 330, and a voice over air interface 390 from the mobile telephone 350 to the anchor MSC 330. Thus, the initial connection between the telephone 310 and the anchor MSC 330 involves two VoIP connections 370, 380

At some point, the mobile telephone 350 will move out of the service area for the anchor MSC 330, and into the service area for the target MSC 340. At this time, the anchor MSC 330 will determine that a handoff forward operation should occur, in step 400. First, a HANDOFFMEASUREMENTREQUEST 410 is made from the anchor MSC 330 to the target MSC 340 in step 410. A handoffmeasurementrequest response is returned from the target MSC 340 to the anchor MSC 330 in step 420. Then, a FACILITIESDIRECTIVE to secure the resources necessary for a call connection between the anchor MSC 330 and the target MSC 340 is sent in step 430. Such resources as a dedicated voice trunk 360 are then seized for use in the call connection to be established between the MSCs 330, 340. These resources are provided in step 440, and a facilitiesdirective response is returned from the target MSC 340 to the anchor MSC 330 in step 450. A handoff order to the mobile telephone 350 is sent from the anchor MSC 330 in step 460, and the mobile telephone 350 arrives on the voice channel in step 470. The target MSC 340 then completes the voice call path connection between the mobile telephone 350 and the trunk in step 480, and establishes the voice over air interface with the mobile telephone 350 in step 490. An MSONCHANNEL message is then sent from the target MSC 340 to the anchor MSC 330 in step 500. At this point, the anchor MSC 330 completes the voice call path connection between the anchor MSC 330 and the target MSC 340 in step 510, and establishes the voice trunk connection 520. VoIP connections 370, 380 now exist between the telephone 310 and the anchor MSC 330. In addition, a voice over air interface 490 exists between the mobile telephone 350 and the target MSC 340, and the voice over trunk connection 520 has been established. However, if a dedicated voice trunk 360 is not available to be seized as a resource by the target MSC 340, the call connection cannot be established between the mobile telephone 350 and the telephone 310, and the call will be dropped. As the number of MSCs increases (e.g., as the mobile telephone 350 roams out of the service areas of the MSCs 330, 340), the scenario gets more complicated, such that other voice trunks and network resources (e.g., timers) must be dedicated to serving the mobile subscriber operating the mobile telephone 350.

Therefore, what is needed, is a method and apparatus using available protocols to obviate the need for voice trunks used to carry speech communication between network subscribers after a handoff operation occurs. Further, such a method and apparatus should provide a way to communicate between network subscribers which does not require tandem MSCs when a call is handed off by way of multiple MSCs. The method and apparatus should be able to make use of commonly available protocols, and should be useful in any type of wireless telecommunication network such as ANSI, Global System Mobile (GSM), and Personal Digital Cellular (PDC) networks.

### SUMMARY OF THE INVENTION

The invention provides a method and apparatus for utilizing Voice over Internet Protocol (VoIP) operations to substitute for the allocation of voice trunks in a conventional telecommunications network during intersystem handoff operations. In the network reference model of the invention, Mobile Switching Centers ( MSCs) are connected to the Internet via VoIP gateways and Internet access servers. Such Internet connections enable sending voice and signaling messages using VoIP operations. Thus, the apparatus may include a pair of VoIP gateways in electronic communication with mobile switching centers (typically using Internet access services), or a pair of mobile switching centers in electronic communication with corresponding VoIP gateways and an Internet Protocol network.

The apparatus of the invention thus includes anchor and serving MSCs connected to the Internet using VoIP gateways and Internet access servers. Target MSCs may also be included, connected to the Internet using a VoIP gateway/Internet access server combination so that handoff forward call connection operations can be conducted using VoIP.

The method of the invention typically includes determination that a handoff forward call connection operation should occur. Next, the method requires verification that a designated channel of the Target MSC is available to support the mobile station being handed off, as well as the allocation of a second VoIP gateway to the Target MSC. Finally, the voice path is completed by establishing voice pathways between the VoIP gateways and the MSCs. Normally, formatting and recovery of the voice audio signals will occur within the VoIP gateways as the signals are sent and received respectively, from the MSCs.

### BRIEF DESCRIPTION OF THE DRAWINGS

A more complete understanding of the structure and operation of the present invention may be had by reference to the following detailed description when taken in conjunction with the accompanying drawings, wherein:

FIG. 1, previously described, is a prior art block diagram illustrating handoff forward methodology;

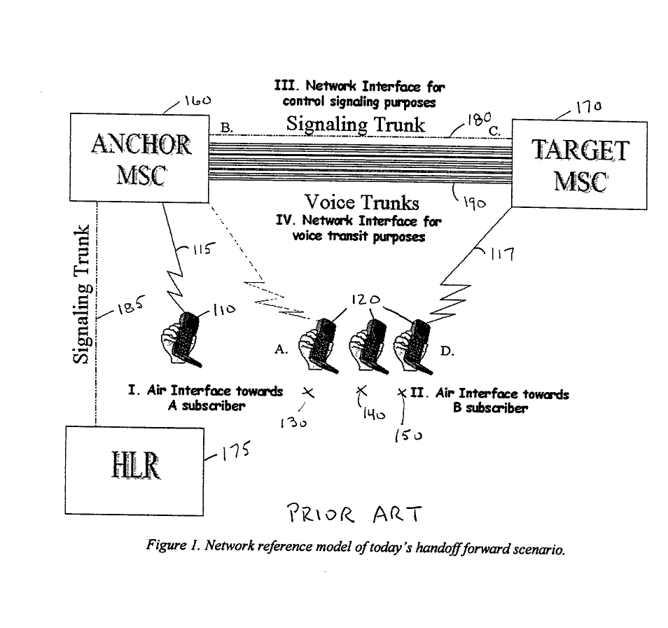

FIG. 2, previously described, is a prior art network signal flow diagram illustrating handoff forward operations using voice trunks;

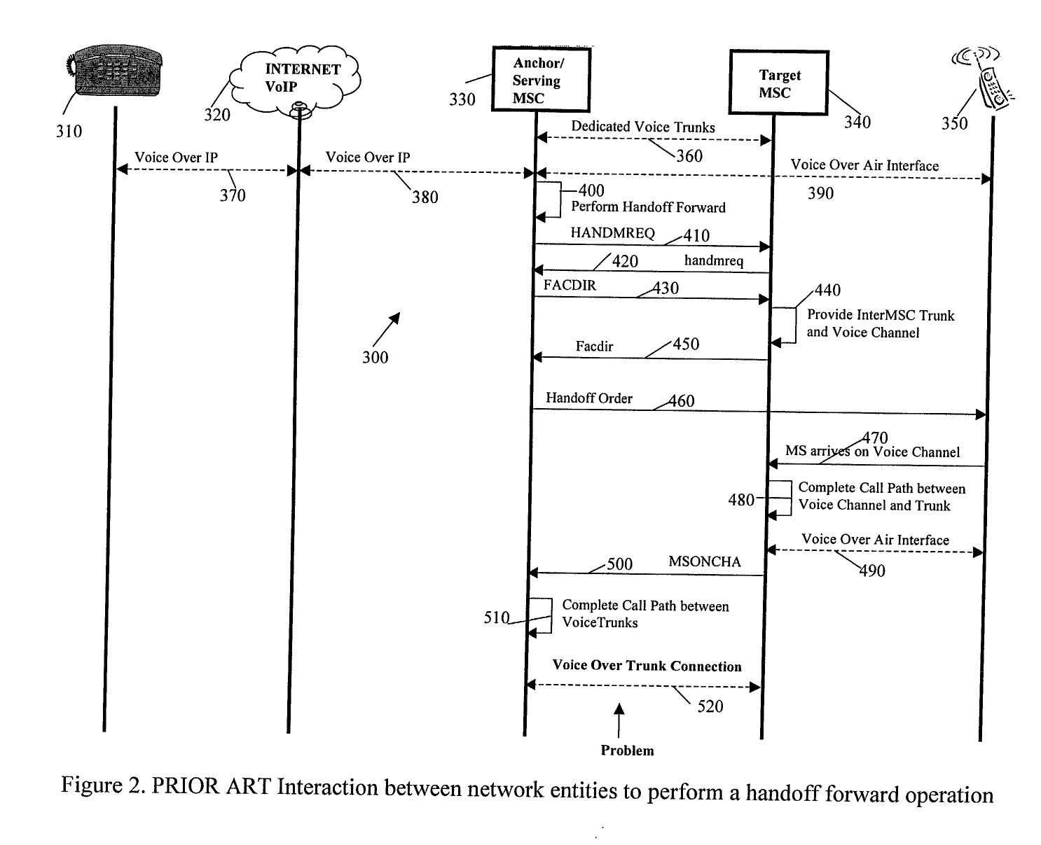

FIG. 3 is a network block diagram illustrating the apparatus of the present invention;

FIG. 4 is a network signal flow diagram illustrating the method of the present invention for inter-exchange handoff operations; and

FIG. 5 is a network signal flow diagram illustrating the method of the present invention using handoff-to-third with path minimization operations.

### DETAILED DESCRIPTION OF PRESENTLY PREFERRED EXEMPLARY EMBODIMENTS

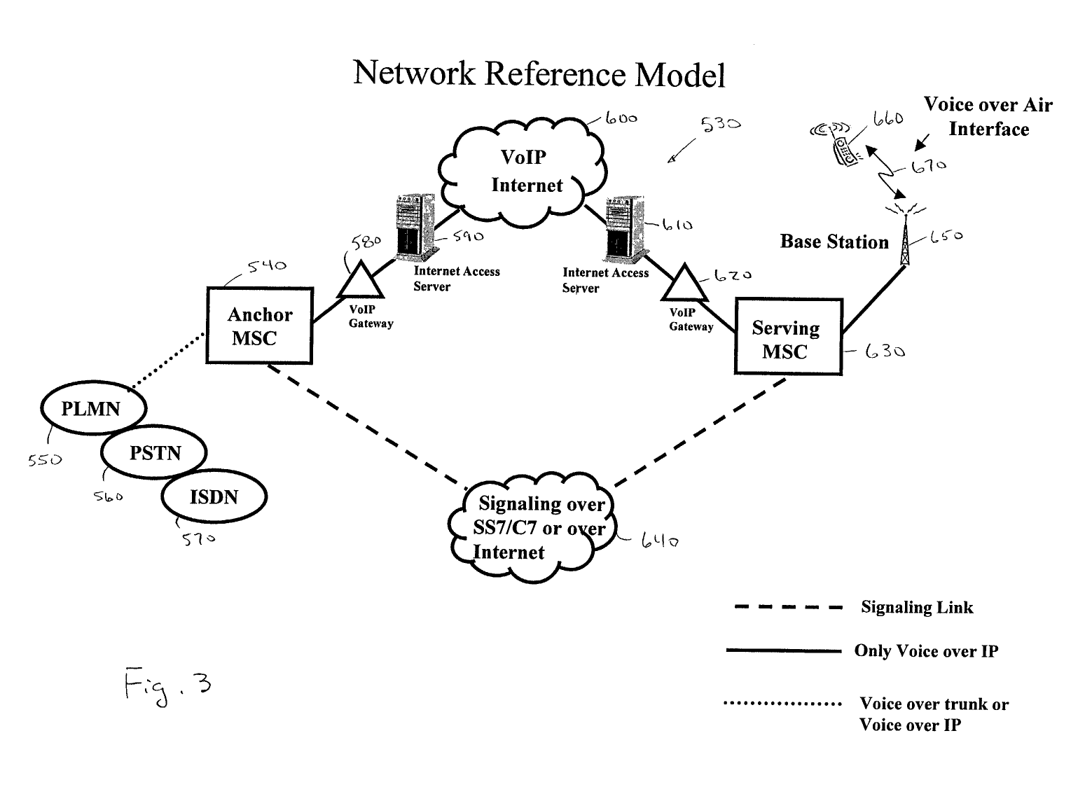

The invention provides the advantage of using VoIP technology as part of a method and apparatus to perform inter-exchange call handoff operations. Turning now to FIG. 3, a proposed network model wherein the invention is embodied can be seen. In essence, signaling trunks and voice trunks between Mobile Switching Centers (MSCS) are replaced by a network (e.g., the Internet), the VoIP protocol, and various gateways and servers. The resulting network 530 supports handoff forward, handoff back, handoff to third, handoff with tandem, and handoff with path minimization operations.

At the center of the reference network 530 lies the Internet 600. Access to the Internet 600 is provided using VoIP gateways 580, 620 and Internet access servers 590, 610. Thus, an Anchor MSC 540 can communicate with the Internet 600 using VoIP by way of the VoIP gateway 580 and the Internet access server 590 (which may be separate physical units, or integrated into a single physical unit). Similarly, the serving MSC 630 can communicate with the Internet 600 using VoIP by way of the VoIP gateway 620 and the Internet access server 610 (which may also be separate units, or integrated into a single unit). Typically, two VoIP gateways 580, 620 are required to eliminate the need for a voice trunk. Telephone service subscribers may communicate, for example, with the anchor MSC 540 using the Public Land Mobile Network (PLMN) 550, the Public Switching Telephone Network (PSTN) 560, or an Integrated Services Digital Network (ISDN) 570. Typically, a mobile telephone 660 subscriber will make use of an air interface 670 to communicate with a base station 650 and a Serving MSC 630 as its entry point into the network 530. As noted in FIG. 3, the signaling link between the MSCs 540, 630 can be supported by using the Signaling System 7 (SS7/C7) signaling trunks 640, or the Internet 600. Of course, signaling using the signaling trunks 640 and the SS7 protocol are well known to those skilled in the art.

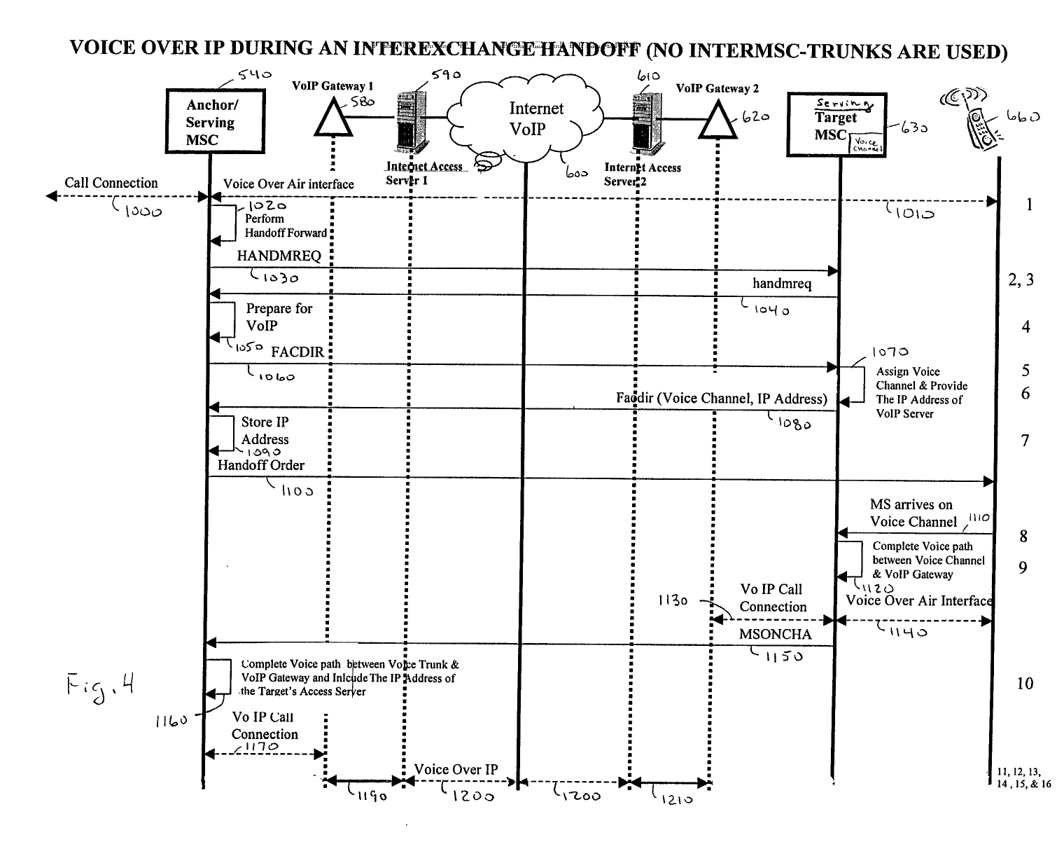

FIG. 4 illustrates a network signaling flow diagram demonstrating the method and apparatus of the invention implementing a handoff forward operation. When the final voice connection is established, it includes a VoIP interface (between the PSTN subscriber, not shown, and the Anchor MSC 540), a VoIP interface (between the anchor MSC 540 and the new Serving MSC 630), and a voice over air interface (between the new Serving MSC 630 and the Mobile Station (MS) 660. The signaling messages between the MSCs can be sent using conventional signaling trunks, or over the Internet.

In FIG. 4, the network elements, including the Internet 600, the access servers 590, 610, the gateways 580, 620, and the MSCs 540, 630, are identical or similar to those described in FIG. 3. Similarly, the MS 660 corresponds to the telephone 660 in FIG. 3.

Initially, there is a conventional call connection 1000 between the originating PSTN subscriber (not shown) and the Anchor/Serving MSC 540, wherein the voice information is sent to the MS served by the anchor MSC 540 using an air interface 1010. At some point, as the MS 660 moves away from the MSC 540, the MSC 540 determines that a handoff to an adjacent candidate MSC is appropriate. This occurs in step 1020. A HANDOFFMEASUREMENTREQUEST message 1030 is sent from the anchor MSC 540 to the potential Target MSC 630. A handoffmeasurementrequest response 1040 is returned from the Target MSC 630 to the Anchor MSC 540, which results in verifying that the MSC 630 will be the Target MSC 630 for the handoff operation.

The Anchor MSC 540 then allocates the first VoIP gateway 580 in step 1050 to prepare for VoIP communication from the Anchor MSC 540 to the Target MSC 630. The Anchor MSC 540 then sends a FACILITIESDIRECTIVE Invoke message 1060 to the Target MSC 630, which directs the Target MSC 630 to initiate a handoff forward task. In step 1070, after receipt of the FACILITIESDIRECTIVE message, the Target MSC 630 allocates the second VoIP gateway 620 and assigns a voice channel. The Target MSC 630 sends the facilitiesdirective response 1080 to the Anchor MSC 540, including an indication that a voice channel is available, and the Internet Protocol (IP) address information for the second VoIP gateway 620. The Anchor MSC 540 then stores the IP address of the second VoIP gateway 620 in step 1090.

At this point, a Mobile Handoff Order 1100 is sent to the MS 660, to indicate that the MS 660 should be attached to the newly-assigned voice channel of the target MSC 630. The MS 660 then arrives on the designated voice channel of the Target MSC 630 in step 1110. The Target MSC 630 then completes the voice call path between the MS 660 voice channel and the second VoIP gateway 620 in step 1120. At this time, the Target MSC 630 completes the voice call path connection between the MS 660 voice channel in the second VoIP gateway 620 in step 1130, establishes the voice over air interface with the MS 660 in step 1140, and sends a MOBILESTATIONONCHANNEL message 1150 to the Anchor MSC 540. It should be noted that using the VoIP gateways 580, 620 obviates the need for conventional inter-MSC voice trunks.

After receiving the MOBILESTATIONONCHANNEL message 1150, the Anchor/Serving MSC 540 completes the voice call path 1170 between the call connection and the first VoIP gateway 580 in step 1160. The Anchor/Serving MSC 540 also sends a request to the first Internet access server 590, including the IP address of the second VoIP gateway 620 so that voice data, using VoIP, can be sent to the Target MSC 630. This also occurs in step 1160. Thus, the Anchor/Serving MSC 540 is simply known as the Anchor MSC 540.

At this point, the VoIP link between the Anchor MSC 540 and the MS 660, is complete. The VoIP link includes the VoIP call connections 1130, 1170;, the network connections 1190 and 1210 between the first and second VoIP gateways 580, 620 and the first and second Internet access servers 590, 610, respectively; and the network IP connections 1200 between the Internet access servers 590 and 610. Communication occurs by sending voice audio from the Anchor MSC 540 to the first VoIP gateway 580, converting or formatting the voice audio into a format suitable for transmission over the network to the second Internet access server 610 using the first Internet access server 590 (i.e., VoIP formatted voice), receiving the formatted voice audio at the second Internet access server 610, and recovering the original voice audio at the second VoIP gateway 620 (i.e., converting the VoIP formatted voice-to-voice audio), receiving the recovered audio at the Serving MSC 630, and sending the voice audio from the Serving MSC 630 to the MS 660 using the assigned voice channel. Using VoIP to send voice from one VoIP gateway 580 to another VoIP gateway 620 are well known to those skilled in the art, as described in the document “Voice over IP (VoIP)” sponsored by Technology Networks as part of its Technology Guide Series, herein incorporated by reference in its entirety (See VOICE OVER IP (VOIP) (Jerry Ryan ed., The Applied Technologies Group, Inc. 1998)). A series of similar steps are performed by the new Serving MSC 630, working backward through the chain of the second VoIP gateway 620, the second Internet access server 610, the Internet 600, the first Internet access server 590, the first VoIP gateway 580, and the Anchor MSC 540 to send voice audio from the MS 660 to the Anchor MSC 540, and on through the call connection 1000 to the originating subscriber.

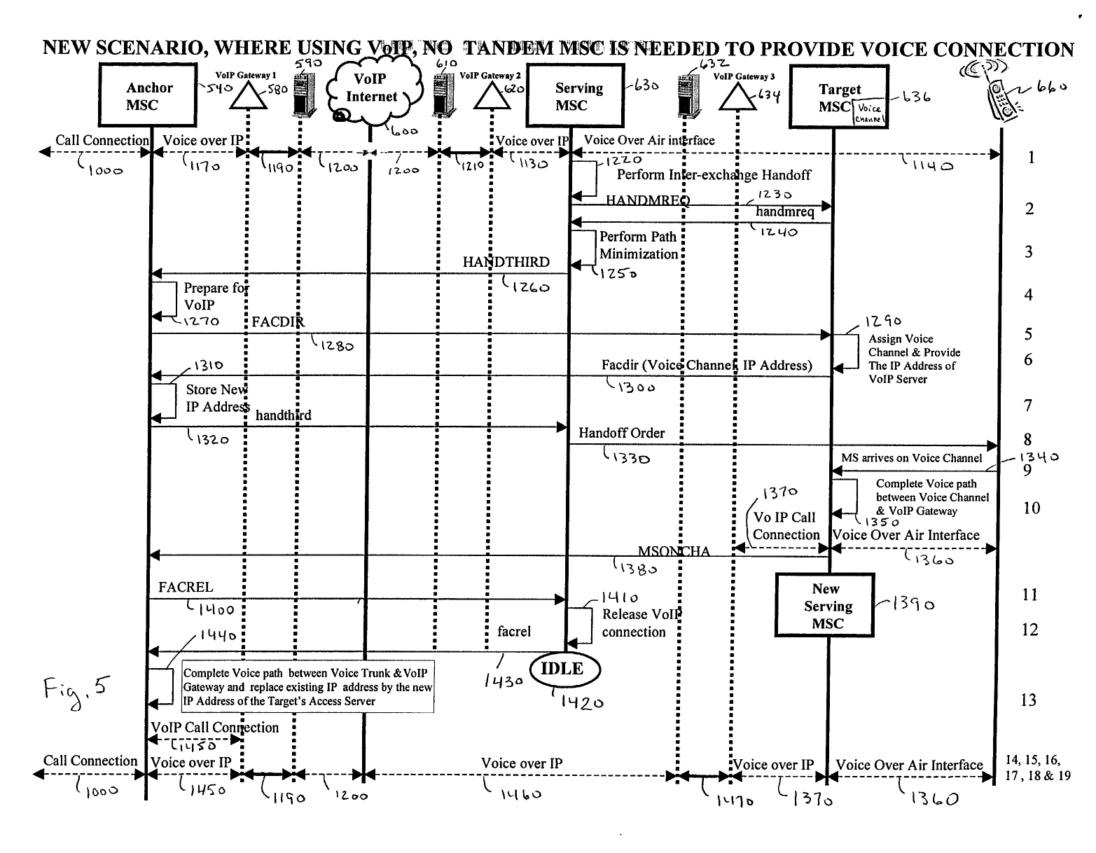

Turning now to FIG. 5, the apparatus and method of the invention used to implement a handoff-to-third with path minimization operation (no Tandem MSC is needed) can be seen. When the final voice connection is established, it includes VoIP interfaces 1450, 1370; the network connections 1190, 1470; and the VoIP network connections 1200, 1460; along with the voice over air interface 1360 between the MS 660 and the Target MSC 636. As noted above, signaling messages between the MSCs 540, 630, and 636 can be sent over conventional signaling trunks, or over the Internet 600. Again, the illustrated network elements correspond to those described in FIG. 4, with the addition of a third VoIP gateway 634 operating through a third Internet access server 632, and an additional MSC 636, to which the MS 660 is handed off from the Serving MSC 630. Initially, the link between the Serving MSC 630 and the Anchor MSC 540 is established as described for the network of FIG. 4.

As the MS 660 moves out of the service area of the serving MSC 630, the serving MSC 630 determines that a handoff to an adjacent candidate MSC is needed (in this case, the potential Target MSC 636) in step 1220. The Serving MSC 630 then sends a HANDOFFMEASUREMENTREQUEST message 1230 from the Serving MSC 630 to the candidate Target MSC 636. After receiving the handoffmeasurementrequest response 1240, the Serving MSC 630 determines that the call should indeed be handed off to the candidate Target MSC 636, and that path minimization may be possible. This determination is made in step 1250. A HANDOFFTOTHIRD Invoke message 1260 is then sent from the Serving MSC 630 to the Anchor MSC 540, requesting the Anchor MSC 540 to perform a handoff with path minimization.

At this time, the Anchor MSC 540 prepares to establish a VoIP call connection 1450 by allocating the first VoIP gateway 580 in step 1270 to redirect the call connection to the new MSC (636). The Anchor MSC then sends a FACILITIESDIRECTIVE Invoke message 1280 to the Target MSC 636 to initiate allocation of resources. After receipt of the FACILITIESDIRECTIVE message 1280, the Target MSC 636 allocates the third VoIP gateway 634 and assigns a voice channel for use by the MS 660 in step 1290. The Target MSC 636 then sends a facilitiesdirective response 1300 to the Anchor MSC 540, including an indication that a voice channel has been assigned, and the IP address information for the third VoIP gateway 634. Upon receipt of the facilitiesdirective response 1300, the Anchor MSC 540 stores the third VoIP gateway 634 IP address in step 1310 and sends a handofftothird response 1320 to the Serving MSC 630.

After receiving the handofftothird response 1320, the Serving MSC 630 sends a Mobile Handoff Order 1330 to the MS 660, which indicates that the MS 660 should attach itself to the newly-assigned voice channel on the Target MSC 636. The handoff order is given in step 1330, and the MS 660 arrives on the assigned voice channel in step 1340.

The Target MSC 636 then completes the voice call connection 1370 between the voice channel and the third VoIP gateway 634 in step 1350, establishes the voice over air interface with the MS 660 in step 1360, and sends a MOBILESTATIONONCHANNEL message 1380 to the Anchor MSC 540 (i.e., the initiator of the handofftothird task). At this time, the Target MSC 636 is designated as the new Serving MSC 636 in step 1390.

Upon receipt of the MOBILESTATIONONCHANNEL message, the Anchor MSC 540 sends a FACILITIESRELEASE message 1400 to the (old) Serving MSC 630 so that the second VoIP gateway 620 and second Internet access server 610 can be released, along with the VoIP connection 1130, which is no longer needed. In step 1410, the VoIP connection 1130 is released, along with the second VoIP gateway 620, the second Internet access server 610, and the (old) Serving MSC 630. The Serving MSC 630 marks the second VoIP gateway 620 as idle in step 1420 and returns a facilitiesrelease response 1430 to the Anchor MSC 540.

Upon receipt of the facilitiesrelease response 1430, the Anchor MSC 540 completes the voice call path connection 1450 between the voice trunk and the first VoIP gateway 580 in step 1440. The Anchor MSC 540 also sends a request to the first Internet access server 590, via the first VoIP gateway 580 (including the IP address of the third VoIP gateway 634), to enable VoIP operations from the Target MSC 636. At this point, the VoIP link between the Anchor MSC 540 and the Target MSC 636 is complete. The link includes the VoIP call connections 1450, 1370; the network connections 1190, 1470; and the VoIP Internet connections 1200, 1460. Of course, the call connection 1000 and the voice over air interface 1360 are used to complete communications between the MS 660 and the originating subscriber (not shown). As with the scenario illustrated in FIG. 4, the communication connection between the MS 660 and the originating subscriber does not need to use any voice trunks, and may also eliminate the use of signaling trunks. In the network operations illustrated by FIG. 5, only the first and third VoIP gateways 580, 634 and the first and third Internet access servers 590, 632 are required for voice communication between the Anchor MSC 540 and the Target MSC 636.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. An apparatus for conducting communication operations between a first mobile switching center and a second mobile switching center, comprising:
a first Voice over Internet Protocol (VoIP) gateway in electronic communication with the first mobile switching center and an Internet Protocol (IP) network; and
a second VoIP gateway in electronic communication with the second mobile switching center and the IP network, wherein the first VoIP gateway receives voice audio from the first mobile switching center and the second VoIP gateway receives voice audio from the second mobile switching center, and wherein the first VoIP gateway converts the voice audio received from the first mobile switching center into a first VoIP-formatted audio for communicating speech information from the first mobile switching center to the second mobile switching center, and wherein the second VoIP gateway converts the voice audio received from the second mobile switching center into a second VoIP-formatted audio for communicating speech information from the second mobile switching center to the first mobile switching center.

2. The apparatus of claim 1, wherein the first and second VoIP gateways are integrated into the first and second mobile switching centers, respectively.

3. The apparatus of claim 1, wherein the first VoIP gateway is electrically coupled to the IP network using a first Internet access server, and wherein the second VoIP gateway is electrically coupled to the IP network using a second Internet access server.

4. The apparatus of claim 1, wherein the first VoIP gateway includes a conversion means for converting the voice audio to VoIP formatted voice.

5. The apparatus of claim 1, wherein the second VoIP gateway includes a conversion means for converting the VoIP formatted and voice-to-voice audio.

6. A method of providing VoIP formatted communications during an inter-exchange handoff operation within a telecommunications network including a Target MSC (TMSC) having a designated channel, and a Mobile Station (MS) served by a Serving MSC (SMSC), wherein a handoff forward call connection operation occurs from the SMSC to the TMSC, comprising the steps of:
determining that the handoff forward call connection operation from the SMSC to the TMSC should occur;
allocating a first VoIP gateway to the SMSC;
allocating a second VoIP gateway including an IP identification address to the TMSC;
completing a second voice path between the designated channel and the second VoIP gateway; and
completing a first voice path between the SMSC and the first VoIP gateway,
wherein the first VoIP gateway is in electronic communication with the second VoIP gateway.

7. The method of claim 6, further comprising the steps of:
assigning the designated channel to the TMSC; and
moving the MS to the designated channel of the TMSC.

8. The method defined in claim 6, further including the steps of sending an unformatted voice audio signal from the SMSC to the first VoIP gateway;
formatting the unformatted voice audio signal within the first VoIP gateway to provide a formatted voice audio signal for transmission over an Internet Protocol (IP) network in electronic communication with the first and second VoIP gateway;
transmitting the formatted voice audio from the first VoIP gateway to the second VoIP gateway over the IP network using the IP identification address of the second VoIP gateway; and
receiving the formatted voice audio at the second VoIP gateway and recovering the unformatted voice audio signal for sending to the MS.

9. The method defined by claim 6, further including the steps of:
formatting a voice over air interface audio signal by the second VoIP gateway to provide a formatted voice over air signal for voice transmission over an IP network in electronic communication with the first and second VoIP gateway;
transmitting the formatted voice air interface audio signal from the second VoIP gateway to the first VoIP gateway over the IP network; and
receiving the formatted voice over air signal at the first VoIP gateway and recovering the voice over air signal for sending to a call connection maintained by the

10. A method of providing Voice over Internet Protocol (VOIP) operations during an inter-exchange handoff forward with path minimization call connection operation within a telecommunications network including an Anchor MSC (AMSC), a Target MSC (TMSC) having a designated channel, and a Mobile Station (MS) served by a Serving MSC (SMSC), wherein the AMSC uses a first VoIP gateway to communicate with an internet protocol (IP) network, the SMSC uses a second VoIP gateway to communicate with the IP network, and the TMSC uses a third VoIP gateway to communicate with the IP network, and wherein the handoff forward with path minimization call connection operation occurs from the AMSC to the TMSC, comprising the steps of:
determining that a handoff forward call connection operation to the TMSC should occur;
verifying that path minimization is supported by the AMSC;
allocating the first VoIP gateway to the AMSC;
allocating the third VoIP gateway including an IP identification address to the TMSC;
storing the IP identification address in the AMSC;
completing a voice path between the designated channel and the third VoIP gateway, wherein the first VoIP gateway is in electronic communication with the third VoIP gateway; and
directing the SMSC to release the second VoIP gateway.

11. The method of claim 10, comprising the steps of:
verifying that the designated channel is available to support the MS; and
moving the MS to the designated channel.

12. The method defined in claim 10, further comprising the steps of:
sending an unformatted voice audio signal from the AMSC to the first VoIP gateway;
formatting the unformatted voice audio signal at the first VoIP gateway into a format suitable for transmission over the IP network;
transmitting the formatted voice audio signal from the first VoIP gateway to the third VoIP gateway over the IP network; and
receiving the formatted voice audio signal at the third VoIP gateway and recovering the unformatted voice audio signal for sending over an air interface to the MS.

13. The method of claim 10, further comprising the steps of:
sending an unformatted voice over air interface audio signal from the TMSC to the third VoIP gateway;
formatting the unformatted voice over air interface audio signal at the third VoIP gateway into a format suitable for transmission over the IP network;
transmitting the formatted voice over air interface audio signal from the third VoIP gateway to the first VoIP gateway over the IP network; and
receiving the formatted voice over air interface audio signal at the first VoIP gateway and recovering the unformatted voice over air interface audio signal for sending over a call connection maintained by the AMSC.

14. An apparatus utilizing a first and second Voice over Internet Protocol (VoIP) gateway in electronic communication with an Internet Protocol (IP) network to substitute for the allocation of voice trunks within a telecommunications network, comprising:
a first mobile switching center in electronic communication with the first VoIP gateway; and
a second mobile switching center in electronic communication with the second VoIP gateway, wherein the first and second VoIP gateways receive voice audio from the first and second mobile switching centers, wherein the first VoIP gateway converts the voice audio from the first mobile switching center into a first VoIP-formatted audio for communicating speech information from the first mobile switching center to the second mobile switching center, and wherein the second VoIP gateway converts the voice audio from the second mobile switching center into a second VoIP-formatted audio for communicating speech information from the second mobile switching center to the first mobile switching center.

15. The apparatus of claim 14, wherein the first VoIP gateway is integrated into the first mobile switching center, and wherein the second VoIP gateway is integrated into the second mobile switching center.

16. The apparatus of claim 14, wherein the first VoIP gateway is electrically coupled to the IP network using a first Internet access server, and wherein the second VoIP gateway is electrically coupled to the IP network using a second Internet access server.

17. The apparatus of claim 14, wherein the first VoIP gateway includes a conversion means for converting the voice audio to VoIP formatted voice.

18. The apparatus of claim 14, wherein the second VoIP gateway includes a conversion means for converting the VoIP formatted and voice-to-voice audio.
